(19) United States
(12) Patent Application Publication
(10) Pub. No.: US 2015/0025178 A1
(43) Pub. Date: Jan. 22, 2015

(54) AMINE CURABLE EPOXY RESIN COMPOSITION

(71) Applicant: Construction Research & Technology GmbH, Trostberg (DE)

(72) Inventors: Derek Jingui Jiang, Shanghai (CN); Peter Congxiao Wang, Shanghai (CN); Timothy Marc Handyside, Essex Elmdon (GB); Iris Chunbin Zhao, Shanghai (CN)

(21) Appl. No.: 14/383,189

(22) PCT Filed: Feb. 26, 2013
(86) PCT No.: PCT/EP2013/053762

§ 371 Date: Sep. 5, 2014

(30) Foreign Application Priority Data
Mar. 9, 2012 (CN) PCT/CN2012/072130

(51) Int. Cl. C08G 59/50; C04B 41/48; C08G 59/62; C08K 3/36; C08G 59/24; C08G 59/20

(52) U.S. Cl. CPC C08G 59/504; C08G 59/5033; C08G 59/245; C08G 59/20; C08G 59/62; C08K 3/36; C04B 41/4853
USPC 523/466; 528/103; 523/400

(57) ABSTRACT

The present invention relates to an amine curable epoxy resin composition comprising: (A) epoxy resin component comprising: 8-31 wt % of diglycidyl ether of bisphenol A, 3-14 wt % of diglycidyl ether of bisphenol F, 1-5 wt % of monoglycidylether, 0.6-5 wt % of alkylsulphonic phenyl ester, 0.16-1 wt % of wetting and dispersing agent, 0.16-1 wt % of defoamer, and 5-40 wt % of barium sulfate; (B) hardener component comprising: 3-18 wt % of first amine based composition, and 2-12 wt % of second amine based composition, wherein the first amine based composition comprises N,N′-bis(3-aminomethylbenzyl)-2-hydroxytrimethylenediamine represented by the following formula (I) and m-xylylenediamine, and the second amine based composition comprises the reaction products of m-xylylenediamine and styrene represented by the following formula (II) and m-xylylenediamine, wherein A is phenylene, and each of R₁, R₂ and R₃ independently represents hydrogen or phenylethyl; wherein the sum of each component content is 100 wt %, and each weight percentage is based on the total weight of the amine curable epoxy resin composition. The invention also relates to use of the amine curable epoxy resin composition as primer, topcoat and screeds for application on concrete.

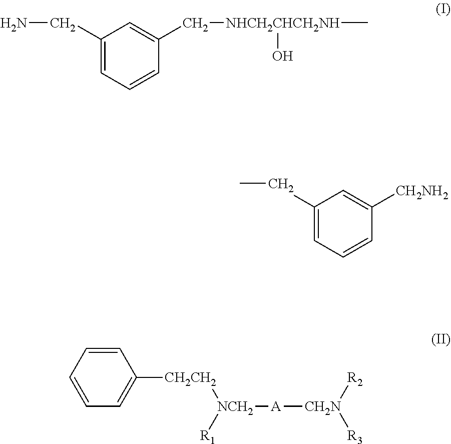

### TECHNICAL FIELD

The invention relates to an amine curable epoxy resin composition. The invention also relates to use of the amine curable epoxy resin composition as primer, topcoat and screeds for application on concrete.

### BACKGROUND OF ART

Amine curable epoxy resin compositions are used broadly in the floorings and coatings. For the moment, amine curable epoxy resin compositions in the market have longer Return to Service time or shorter pot life at room temperature, which causes them not able to being used easily at room temperature. GB 2 286 592 A disclosed an amine curable epoxy resin composition, wherein the composition with hardener GASMAMINE 328 has compressive strength of 30.5 MPa after application for 24 hours. However, there is still a need that amine curable epoxy resin compositions having higher compressive strength, shorter Return to Service time and longer pot life are provided.

### INVENTION SUMMARY

Accordingly, the invention provides an amine curable epoxy resin composition comprising:

(A) epoxy resin component comprising:
8-31 wt % of diglycidyl ether of bisphenol A,
3-14 wt % of diglycidyl ether of bisphenol F,
1-5 wt % of monoglycidylether,
0.6-5 wt % of alkylsulphonic phenyl ester,
0.16-1 wt % of wetting and dispersing agent,
0.16-1 wt % of defoamer, and
5-40 wt % of barium sulfate;

(B) hardener component comprising:
3-18 wt % of first amine based composition, and
2-12 wt % of second amine based composition,
wherein the first amine based composition comprises N,N′-bis(3-aminomethylbenzyl)-2-hydroxytrimethylenediamine represented by the following formula (I) and m-xylylenediamine, and the second amine based composition comprises the reaction products of m-xylylenediamine and styrene represented by the following formula (II) and m-xylylenediamine,

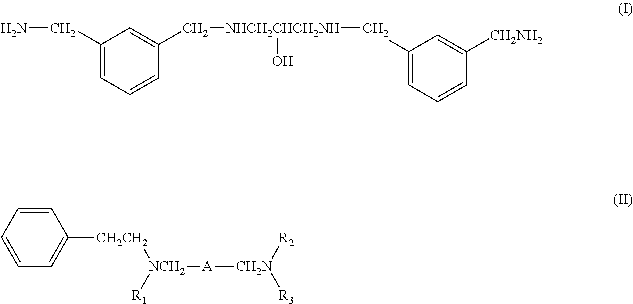

wherein A is phenylene, and each of R₁, R₂ and R₃ independently represents hydrogen or phenylethyl;

wherein the sum of each component content is 100 wt %, and each weight percentage is based on the total weight of the amine curable epoxy resin composition.

The invention also provides a hardener comprising 20-90 wt % of first amine based composition and 10-80 wt % of second amine based composition, wherein the first amine based composition comprises N,N′-bis(3-aminomethylbenzyl)-2-hydroxytrimethylenediamine represented by the following formula (I) and m-xylylenediamine, and the second amine based composition comprises the reaction products of m-xylylenediamine and styrene represented by the following formula (II) and m-xylylenediamine,

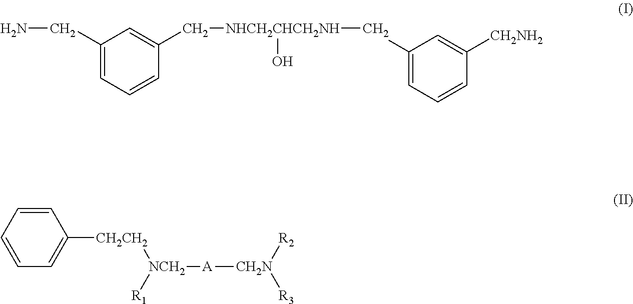

wherein A is phenylene, and each of R₁, R₂ and R₃ independently represents hydrogen or phenylethyl;

wherein the sum of each component content is 100 wt %, and each weight percentage is based on the total weight of the first amine based composition and the second amine based composition.

The invention also provides use of the amine curable epoxy resin composition as primer, topcoat and screeds for application on concrete.

The amine curable epoxy resin composition of the present invention has pot life of more than 25 minutes, Return to Service time of less than 12 hours and compressive strength of more than 80 MPa after application for 20 hours at room temperature.

### EMBODIMENTS

In one embodiment of the present invention, the invention provides an amine curable epoxy resin composition comprising:

(A) epoxy resin component comprising:
8-31 wt % of diglycidyl ether of bisphenol A,
3-14 wt % of diglycidyl ether of bisphenol F,
1-5 wt % of monoglycidylether,
0.6-5 wt % of alkylsulphonic phenyl ester,
0.16-1 wt % of wetting and dispersing agent,
0.16-1 wt % of defoamer, and
5-40 wt % of barium sulfate;

(B) hardener component comprising:
3-18 wt % of first amine based composition, and
2-12 wt % of second amine based composition,
wherein the first amine based composition comprises N,N′-bis(3-aminomethylbenzyl)-2-hydroxytrimethylenediamine represented by the following formula (I) and m-xylylenediamine, and the second amine based composition comprises the reaction products of m-xylylenediamine and styrene represented by the following formula (II) and m-xylylenediamine,

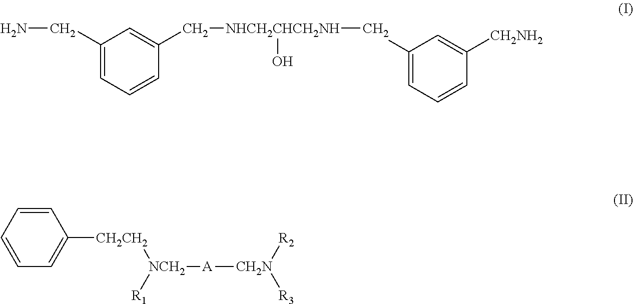

wherein A is phenylene, and each of R₁, R₂ and R₃ independently represents hydrogen or phenylethyl;

wherein the sum of each component content is 100 wt %, and each weight percentage is based on the total weight of the amine curable epoxy resin composition.

In one embodiment of the present invention, the invention provides a hardener comprising 20-90 wt % of first amine based composition and 10-80 wt % of second amine based composition, wherein the first amine based composition comprises N,N′-bis(3-aminomethylbenzyl)-2-hydroxytrimethylenediamine represented by the following formula (I) and m-xylylenediamine, and the second amine based composition comprises the reaction products of m-xylylenediamine and styrene represented by the following formula (II) and m-xylylenediamine,

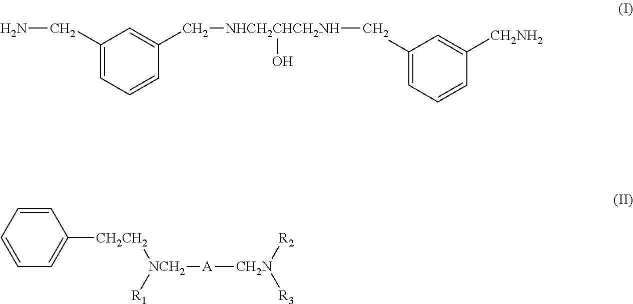

wherein A is phenylene, and each of R₁, R₂ and R₃ independently represents hydrogen or phenylethyl;

wherein the sum of each component content is 100 wt %, and each weight percentage is based on the total weight of the first amine based composition and the second amine based composition.

In one embodiment of the present invention, N,N′-bis(3-aminomethylbenzyl)-2-hydroxytrimethylenediamine represented by the formula (I) is a reaction product of m-xylylenediamine and epichlorhydrin, which can be prepared by known process in the art.

In one embodiment of the present invention, the reaction products of m-xylylenediamine and styrene represented by the formula (II) are prepared according to the process described in CN03149428.5, for example see synthesis example 1.

In one embodiment of the present invention, the amine curable epoxy resin composition may further comprise silica sand. In preferred embodiment of the present invention, the particle size of silica sand is 200 meshes.

In preferred embodiment of the present invention, the content of N,N′-bis(3-aminomethylbenzyl)-2-hydroxytrimethylenediamine is 72-76 wt % of the first amine based composition and the content of m-xylylenediamine is 24-28 wt % of the first amine based composition in the first amine based composition. More preferably, the content of N,N′-bis(3-aminomethylbenzyl)-2-hydroxytrimethylenediamine is about 75 wt % of the first amine based composition and the content of m-xylylenediamine is about 25 wt % of the first amine based composition in the first amine based composition. Said first amine based composition is for example GASKAMINE 328 commercially available from Mitsubishi Gas Chemical Company, Inc.

In preferred embodiment of the present invention, the content of m-xylylenediamine is less than 1 wt % of the second amine based composition in the second amine based composition. Said second amine based composition is for example GASKAMINE 240 commercially available from Mitsubishi Gas Chemical America, Inc.

In another embodiment of the present invention, said hardener component may further comprise CeTePox EW99 H which is a formulation based on alkyl polyamines, and CeTePox EW99 H is for example commercially available from CTP Chemicals and Technologies for Polymers GmbH.

In one embodiment of the present invention, the hardener component may further comprise benzyl alcohol.

In one embodiment of the present invention, the diglycidyl ether of bisphenol A is for example GELR 128 commercially available from Epoxy Base Electronic Material Corporation Limited. The diglycidyl ether of bisphenol F is for example Epikote 862 commercially available from Momentive Specialty Chemicals Inc..

In one embodiment of the present invention, monoglycidylether is for example Araldite DY-E commercially available from Huntsman.

In one embodiment of the present invention, the alkyl in the alkylsulphonic phenyl ester is C12 to C18. More preferably, the alkylsulphonic phenyl ester is dodecylsulphonic phenyl ester. The alkylsulphonic phenyl ester is for example MESAMOIL commercially available from LANXESS.

In preferred embodiment of the present invention, the wetting and dispersing agent is a solution of copolymer with acidic groups, and is for example DISPERBYK-110 commercially available from BYK Additives & Instrument.

In preferred embodiment of the present invention, the defoamer is a defoaming polymer mixture without organic silicon, and is for example BYK 1790 commercially available from BYK Additives & Instrument.

In preferred embodiment of the present invention, the particle size of barium sulfate is preferably 325 meshes.

In one embodiment of the present invention, the amine curable epoxy resin composition can be prepared as follows: (A) epoxy resin component is added into mixer at room temperature, such as high speed mixing machine, and mixed until homogeneity. Then, (B) hardener component is added into the above mixture and mixed until homogeneity. Optionally, silica sand can be added into the mixture of (A) epoxy resin component and (B) hardener component and mixed until homogeneity. Said high speed mixing machine is known to those skilled in the art.

In one embodiment of the present invention, (A) epoxy resin component and (B) hardener component can be packaged separately, and (A) epoxy resin component and (B) hardener component and optionally silica sand are mixed homogeneously before application.

The invention also relates to use of the amine curable epoxy resin composition as primer, topcoat and screeds for application on concrete. The amine curable epoxy resin composition can be applied by processes known to those skilled in the art, for example by using notched trowel, roller and spraying machine etc.

“Return to Service time” used herein represents a time period during which its hardness achieves Shore D 70 after the amine curable epoxy resin composition is applied on concrete with moisture content of 5 wt % at room temperature.

“Pot life” used herein is measured according to method 1 of ISO 10364.

“Compressive strength” used herein is measured according to ASTM C 109.

All percentages are mentioned by weight unless otherwise indicated.

### EXAMPLES

The present invention is now further illustrated by reference to the following examples, however, the examples are used for the purpose of explanation and not intended to limit the scopes of the invention.

### Example 1

125 g of diglycidyl ether of bisphenol A (GELR 128), 54 g of diglycidyl ether of bisphenol F (Epikote 862), 15 g of monoglycidylether (Araldite DY-E), 12 g of alkylsulphonic phenyl ester (MESAMOIL), 3 g of wetting and dispersing agent (DISPERBYK-110), 3 g of defoamer (BYK 1790) and 138 g of barium sulfate are added into high speed mixing machine and mixed until homogeneity , and mixture 1 is obtained. Then, the mixture of 40.2 g of GASKAMINE 328 and 27.2 g of GASKAMINE 240 is added into the mixture 1 and mixed until homogeneity, and mixture 2 is obtained.

Mixture 2 is applied by rolling as primer on concrete with moisture content of 5 wt % at the temperature of 23±2° C. and relative humidity of 50% , and wet film thickness (WFT) is 200 μm.

Mixture 2 and film prepared thereof are measured. The results are listed in table 1.

TABLE 1

| | Viscosity of mixture | Pot life | Return to Service time |
|---|---|---|---|
| Property | (cps) | (minute) | (hour) |
| Example 1 | 1517 | 43 | 7 |

835 g of 200 meshes silica sand is added into the mixture 2 and mixed until homogeneity. Then, the resulted mixture is applied as screeds on concrete with moisture content of 5 wt % at the temperature of 23±2° C. and relative humidity of 50%, and compressive strength is measured as shown in table 2.

TABLE 2

| curing time | compressive strength |
|---|---|
| (hour) | (MPa) |
| 20 | 89.1 |
| 24 | 88.6 |
| 168 | 95.6 |

### Example 2

Mixture of 40.2 g of GASKAMINE 328, 27.7 g of GASKAMINE 240 and 10 g of benzyl alcohol is added into the mixture 1 according to example 1 and mixed until homogeneity, and mixture 3 is obtained.

Mixture 3 is applied by rolling as primer on concrete with moisture content of 5 wt % at the temperature of 23±2° C. and relative humidity of 50% , and wet film thickness (WFT) is 0.5 millimeter.

Mixture 3 and film prepared thereof are measured. The results are listed in table 3.

TABLE 3

| | Viscosity of mixture | Pot life | Return to Service time |
|---|---|---|---|
| Property | (cps) | (minute) | (hour) |
| Example 2 | 1037 | 36 | 8 |

855 g of 200 meshes silica sand is added into the mixture 3 and mixed until homogeneity. Then, the resulted mixture is applied as screeds on concrete with moisture content of 5 wt % at the temperature of 23±2° C. and relative humidity of 50%, and compressive strength is measured as shown in table 4.

TABLE 4

| curing time | compressive strength |
|---|---|
| (hour) | (MPa) |
| 20 | 98.5 |
| 24 | 98.5 |
| 168 | 115.8 |

### Example 3

Mixture of 40.2 g of GASKAMINE 328, 13.4 g of GASKAMINE 240, 13.4 g of CeTePox EW99 H and 10 g of benzyl alcohol is added into the mixture 1 according to example 1 and mixed until homogeneity, and mixture 4 is obtained.

Mixture 4 is applied by scraping as topcoat on concrete with moisture content of 5 wt % at the temperature of 23±2° C. and relative humidity of 50% , and wet film thickness (WFT) is 2.0 millimeters.

Mixture 4 and film prepared thereof are measured. The results are listed in table 5 and table 6.

TABLE 5

| | Viscosity of mixture | Pot life | Return to Service time |
|---|---|---|---|
| Property | (cps) | (minute) | (hour) |
| Example 3 | 1037 | 27 | 8 |

TABLE 6

| curing time | compressive strength |
|---|---|
| (hour) | (MPa) |
| 20 | 140 |
| 24 | 140 |
| 168 | 140 |

### Example 4

854 g of 200 meshes silica sand is added into the mixture 4 according to example 3 and mixed until homogeneity. Then, the resulted mixture is applied as screeds on concrete with moisture content of 5 wt % at the temperature of 23±2° C. and relative humidity of 50%, and compressive strength is measured as shown in table 7.

TABLE 7

| curing time | compressive strength |
|---|---|
| (hour) | (MPa) |
| 20 | 91.1 |
| 24 | 93.5 |
| 168 | 107.5 |

### Example 5

Mixture of 40.2 g of GASKAMINE 328, 27.7 g of GASKAMINE 240 and 20 g of benzyl alcohol is added into the mixture 1 according to example 1 and mixed until homogeneity, and mixture 5 is obtained.

Mixture 5 is applied by scraping as topcoat on concrete with moisture content of 5 wt % at the temperature of 23±2° C. and relative humidity of 50% , and wet film thickness (WFT) is 3.0 millimeters.

Mixture 5 and film prepared thereof are measured. The results are listed in table 8.

TABLE 8

| | Viscosity of mixture | Pot life | Return to Service time |
|---|---|---|---|
| Property | (cps) | (minute) | (hour) |
| Example 5 | 870 | 33 | 12 |

874 g of 200 meshes silica sand is added into the mixture 5 and mixed until homogeneity. Then, the resulted mixture is applied as screeds on concrete with moisture content of 5 wt % at the temperature of 23±2° C. and relative humidity of 50%, and compressive strength is measured as shown in table 9.

TABLE 9

| curing time | compressive strength |
|---|---|
| (hour) | (MPa) |
| 20 | 80.3 |
| 24 | 81.9 |
| 168 | 98.2 |

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1. An amine curable epoxy resin composition comprising:
(A) epoxy resin component comprising:
8-31 wt % of diglycidyl ether of bisphenol A,
3-14 wt % of diglycidyl ether of bisphenol F,
1-5 wt % of monoglycidylether,
0.6-5 wt % of alkylsulphonic phenyl ester,
0.16-1 wt % of wetting and dispersing agent,
0.16-1 wt % of defoamer, and
5-40 wt % of barium sulfate;
(B) hardener component comprising:
3-18 wt % of first amine based composition, and
2-12 wt % of second amine based composition,
wherein the first amine based composition comprises N,N′-bis(3-aminomethylbenzyl)-2-hydroxytrimethylenediamine represented by the following formula (I) and m-xylylenediamine, and the second amine based composition comprises the reaction products of m-xylylenediamine and styrene represented by the following formula (II) and m-xylylenediamine, 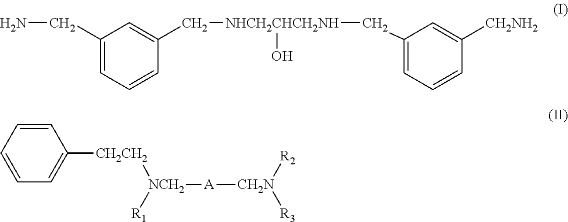
wherein A is phenylene, and each of R₁, R₂ and R₃ independently represents hydrogen or phenylethyl;
wherein the sum of each component content is 100 wt %, and each weight percentage is based on the total weight of the amine curable epoxy resin composition.

2. The amine curable epoxy resin composition according to claim 1, wherein the content of N,N′-bis(3-aminomethylbenzyl)-2-hydroxytrimethylenediamine is 72-76 wt % of the first amine based composition and the content of m-xylylenediamine is 24-28 wt % of the first amine based composition in the first amine based composition.

3. The amine curable epoxy resin composition according to claim 2, wherein the content of m-xylylenediamine is less than 1 wt % of the second amine based composition in the second amine based composition.

4. The amine curable epoxy resin composition according to claim 1, further comprises silica sand.

5. The amine curable epoxy resin composition according to claim 1, wherein the hardener component further comprises benzyl alcohol.

6. The amine curable epoxy resin composition according to claim 1, wherein the alkyl in the alkylsulphonic phenyl ester is C12 to C18.

7. The amine curable epoxy resin composition according to claim 6, wherein the alkylsulphonic phenyl ester is dodecylsulphonic phenyl ester.

8. The amine curable epoxy resin composition according to claim 1, wherein the wetting and dispersing agent is a solution of copolymer with acidic groups.

9. A hardener comprising:
20-90 wt % of first amine based composition, and
10-80 wt % of second amine based composition,
wherein the first amine based composition comprises N,N′-bis(3-aminomethylbenzyl)-2-hydroxytrimethylenediamine represented by the following formula (I) and m-xylylenediamine, and the second amine based composition comprises the reaction products of m-xylylenediamine and styrene represented by the following formula (II) and m-xylylenediamine, 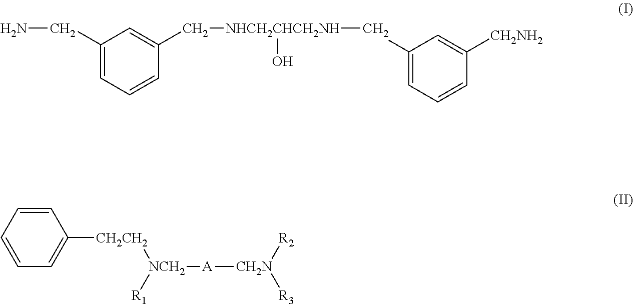
wherein A is phenylene, and each of R₁, R₂ and R₃ independently represents hydrogen or phenylethyl;
wherein the sum of each component content is 100 wt %, and each weight percentage is based on the total weight of the first amine based composition and the second amine based composition.

10. The amine curable epoxy resin composition according to claim 9, wherein the content of N,N′-bis(3-aminomethylbenzyl)-2-hydroxytrimethylenediamine is 72-76 wt % of the first amine based composition and the content of m-xylylenediamine is 24-28 wt % of the first amine based composition in the first amine based composition.

11. The amine curable epoxy resin composition according to claim 10, wherein the content of m-xylylenediamine is less than 1 wt % of the second amine based composition in the second amine based composition.

12. A process for utilizing of the amine curable epoxy resin composition according to claim 1 as primer, topcoat and screeds for application on concrete.

13. The amine curable epoxy resin composition according to claim 9, wherein the content of m-xylylenediamine is less than 1 wt % of the second amine based composition in the second amine based composition.

14. The amine curable epoxy resin composition according to claim 1, wherein the content of m-xylylenediamine is less than 1 wt % of the second amine based composition in the second amine based composition.
